(19) United States
(12) Patent Application Publication
(10) Pub. No.: US 2014/0280347 A1
(43) Pub. Date: Sep. 18, 2014

(54) Managing Digital Files with Shared Locks

(71) Applicant: Daniel BARBER, Tustin, CA (US)

(72) Inventor: Daniel BARBER, Tustin, CA (US)

(73) Assignee: KONICA MINOLTA LABORATORY U.S.A., INC., San Mateo, CA (US)

(21) Appl. No.: 13/831,310

(22) Filed: Mar. 14, 2013

(51) Int. Cl. G06F 17/30

(52) U.S. Cl. CPC G06F 17/30091
USPC 707/783

(57) ABSTRACT

A method for managing the access and use of digital files stored in a file storage networked with multiple servers, including the steps of: a requesting server among the multiple servers that desires to access and use a file stored in the file storage sending to the other servers of the multiple servers a query containing an identification (ID) of the file; each of the other servers receiving the query checking an internal lock list to ascertain whether the file ID is listed therein, if listed then returning a failure message to the requesting server, but if not listed then returning a success message to the requesting server; and the requesting server determining from all returning messages whether a failure message exists, if exists then not to access and use the file, and sending repeated queries at a predetermined time interval, but if not exist then access and use the file, and sending a notice to all other servers when finishing using the file.

### BACKGROUND OF THE INVENTION

1. Field of the Invention

This invention relates to a method of managing digital files, and in particular, it relates to managing access and use of files with shared locks among peer-to-peer users.

2. Description of Related Art

Electronic digital files are widely used in modern document preparation and processing technologies. Documents of tests, images, video clips and others that are traditionally prepared, distributed and viewed in hard paper copies are increasingly prepared and processed in electronic digital formats such as the portable document format (PDF).

Many computer and data processing systems often have shared digital file storage, where multiple computer servers can access the file storage device at the same time. As the number of these servers sharing file storage increase, so will the chance that they need to access a same digital file stored in the file storage at the same time.

In addition, many computer programs and applications now involve “cloud”-based file storage solutions that use cloud storages for digital files. As this option becoming more popular, the problem of having multiple servers need to access a same file from the cloud storage is compounded greatly.

When there is a restriction on a digital file that prohibits the file to be worked on (e.g., edited, revised, modified, changed, etc.) simultaneously by multiple users, the file may be placed in a “lock” (or “locked”) status when it is being worked on by a user. In other words, when no one is working on a digital file stored in a file storage, the file is placed in an “unlock” or (“unlocked”) status, and the status of the file remains unlocked as long as it is not accessed and being worked on. When a user has accessed the file and is working on it, its status is changed to “lock”, so that a subsequent user cannot access and work on it simultaneously. When the user has finished working on the locked file, its status is changed back to “unlock”, so that it can be accessed and worked on thereafter.

However, one problem of the above described file lock scheme is that when a user is denied access of a digital file because it is being locked, the user has no idea as to how long the file will remain locked. The user may check back after a period of time, but oftentimes the file becomes unlocked and accessed by another user during the interim time. This means that the earlier user has lost “priority” to the other user.

One approach to solve this problem so that earlier users who have checked a status of a file may retain their priorities when the file remains locked is to maintain a centralized “queue” on an administrative server or a controller of the file storage that controls and manages the file storage. All status inquiries of a digital file stored in the file storage received are handled by the administrative server. When a subsequent inquiry is received from another server about the locking status of a file, the administrative server will check its internal record to see whether the inquired file is locked. If it is unlocked, then the other server may access and work on the file. If it is locked, then access by the other server is denied, but the identity of the other server is placed on the queue established and maintained for the locked file.

This centralized queue acts as a “master waiting list” for other servers to gain access of the file in turn. The identities of subsequent servers whose access to the same locked file will be placed on the queue in the same order as their inquiries are received. When the file becomes unlocked, the first server on the queue will be granted access of the file first.

There is a need of finding a practical solution that can provide a new approach for managing the access and use of digital files stored in file storages in a peer-to-peer network environment, particularly in a cloud computing/storing environment.

### SUMMARY

There are several limitations of the conventional centralized approach described above. It generally requires an administrative server, or a data processor or controller of the file storage, to manage the digital files stored on the file storage. It also requires the establishment and maintenance of a centralized or master queue for each digital file stored in the file storage that records all servers whose requests for accessing the file have been denied because the file is locked.

These limitations of the conventional approach based on centralized master queues established and maintained for each file stored in a storage become even more problematic with the increasing use of cloud environments in computer network system, where a large and growing number of servers and file storages are coexisting in more decentralized and peer-to-peer relationships.

The embodiments of the present invention provide a practical solution for managing the access and use of digital files stored in file storages in a peer-to-peer network environment, particularly in a cloud computing/storing environment, to prevent simultaneous access and use of a same digital file by multiple users, while prioritizing subsequent user access of the file that is being accessed and used by a current user, based on the priority of an initial inquiry of the file locking status by another user when the file is being accessed and used by the current user, among the computers and servers that are coexisting in a peer-to-peer relationship in a network environment such as a cloud environment.

The embodiments of the present invention are directed to a new method of managing the access and use of digital files stored in file storage with shared locks among peer-to-peer networked servers such as in a cloud environment, to prevent simultaneous use of a same digital file while prioritizing subsequent access of the file that is being used based on the priority of the initial inquiry.

Some embodiments of the present invention provide a method for managing the access and use of digital files stored in file storages with shared locks that prevents any simultaneous access and use of a same digital file by multiple servers.

Some embodiments of the present invention also provide a method for managing the access and use of digital files stored in file storages with shared locks that is suitable for servers and file storages in a computer network environment, particularly a cloud computing/storing environment, by eliminating any centralized administrative server or data processor/controller for managing simultaneous access and use of files stored in a networked file storage.

Some embodiments of the present invention additionally provide a method for managing the access and use of digital files stored in file storages with shared locks that is suitable for servers and file storages in a computer network environment, particularly a cloud computing/storing environment, by eliminating any centralized/master queue established and maintained for a stored file for managing simultaneous access and use of the file.

Some embodiments of the present invention further provide a method for managing the access and use of digital files stored in file storages with shared locks that prioritizes subsequent server access of a digital file that is being accessed and used by a current server, based on the priority of an initial inquiry of the file locking status by another server when the file is being used by the current server.

Additional features and advantages of the invention will be set forth in the descriptions that follow and in part will be apparent from the description, or may be learned by practice of the invention. The objectives and other advantages of the invention will be realized and attained by the structure particularly pointed out in the written description and claims thereof as well as the appended drawings.

To achieve these and/or other objects, as embodied and broadly described, one of the exemplary embodiments of the present invention provides a method for managing the access and use of digital files stored in a file storage networked with multiple servers, comprising the steps of: (a) a requesting server among the multiple servers that desires to access and use a file stored in the file storage sending to the other servers of the multiple servers a query containing an identification (ID) of the file; and (b) each of the other servers receiving the query checking an internal lock list to ascertain whether the file ID is listed therein, (b)(i) if listed then returning a failure message to the requesting server, (b)(ii) if not listed then returning a success message to the requesting server; (c) the requesting server determining from all returning messages whether a failure message exists, (c)(i) if exists then not to access and use the file, and sending repeated queries at a predetermined time interval, (c)(ii) if not exist then access and use the file, and sending a notice to all other servers when finishing using the file.

In a further aspect, another one of the exemplary embodiments of the present invention provides a computer program product that causes a data processing apparatus to perform the above described methods. The computer program product includes a computer usable non-transitory medium (e.g. memory or storage device) having a computer readable program code embedded therein for controlling a data processing apparatus, the computer readable program code configured to cause the data processing apparatus to execute the above described processes.

It is to be understood that both the foregoing general description and the following detailed description are exemplary and explanatory and are intended to provide further explanation of the invention as claimed.

### BRIEF DESCRIPTION OF THE DRAWINGS

FIG. 1 is a schematic block diagram illustrating an exemplary online environment according to one of the embodiments of the present invention.

FIG. 2 is a schematic block diagram illustrating an exemplary data processing apparatus such as a computer or server according to one of the embodiments of the present invention.

FIG. 3 is a flow chart diagram illustrating an exemplary process according to one of the embodiments of the present invention.

### DETAILED DESCRIPTION OF PREFERRED EMBODIMENTS

Embodiments of the present invention provide a method and system for managing the access and use of digital files stored in file storages in a network environment, particularly in a cloud computing/storing environment and especially for servers coexisting in a peer-to-peer relationship, to prevent simultaneous access and use of a same digital file by multiple servers, while prioritizing subsequent server access and use of the file that is being accessed and used by a current server, based on the priority of an initial inquiry of the file locking status by another server when the file is being accessed and used by the current server.

Referring to FIG. 1, there is shown a schematic block diagram illustrating an exemplary online system set up or arrangement 10 in which various embodiments of the present invention may be implemented. The exemplary online system 10 includes one or more servers/computers 20, 30 and 40 that are connected to at least one file storage 50 either locally via a direct link 32 or remotely via an open interconnected computer network 60 such as the Internet.

For example, server 20 is connected to the file storage 50 remotely via the network 60, while server 30 is connected to the file storage 50 locally via the direct link 32. In other instances a group of servers, such as servers 40, are accessed and accessing other servers/storages through a work group layer 42.

Servers 20, 30 and 40 may be server instances, for example Structured Query Language (SQL) Server instances. The server instances may further include load balanced homogeneous instances and/or heterogeneous instances.

Servers 20, 30 and 40 may be computers, server computers, or computer or server systems, such as webservers, where the computer software program(s) and/or application(s) implementing the various processes of the embodiments of the present invention may be installed and executed.

In this application the term “server” generally refers to any computer, server, server computer, server instance, computer or server system, data processor, controller, data processing unit or apparatus, or any suitable system, apparatus or device, and any computer software program or application that are installed or executed on such system, apparatus or device, that may be used to implement the methods or carry out the processes provided by the embodiments of the present invention.

The file storage 50 is used for saving and storing electronic digital files. The file storage 50 may be an internal or external electronic storage device of a server, e.g., server 30, that is accessible locally accessible by the server via direct link 32. The file storage 50 may also be a separate network device that is remotely accessible by servers 20 and 40 via the network 60. The file storage 50 may be, for example, a standard network attached storage (NAS), or a cloud storage system accessible by network protocols such as the Hypertext Transfer Protocol (HTTP) and the File Transfer Protocol (FTP).

A user typically accesses and works on a digital file stored in the file storage 50 by using a computer program or application on a user's computer or on a server that the user can access through a user computer or terminal, such as one of the servers 20, 30 or 40. In this application the term “user” generally refers to anyone who uses the method or related apparatus provided by the embodiments of the present invention. In addition, in this application the terms “user” and “server” may be used interchangeably to refer to a user who uses a server and/or a server that is used by a user.

Referring to FIG. 2, there is shown a schematic block diagram illustrating an exemplary server 100, whereupon various embodiments of the present invention may be implemented. The server 100 typically includes a user input device 110 including, for example, a keyboard and a mouse.

The input device 110 may be connected to the server 100 through a local input/output (I/O) port 120 to enable an operator and/or user to interact with the server 110. The local I/O 120 is also provided for local connections via direct links to other electronic devices such as a file storage, a monitor and/or a printer.

The server 100 typically also has a network I/O port 130 for connection to a computer network such as the Internet, so that the server 100 may remotely communicate with the other servers connected to the computer network.

The server 100 typically has a data processor/controller unit 140 such as a central processor unit (CPU) that controls the functions and operations of the server 100. The data processor/controller unit 140 is connected to various memory devices such as a random access memory (RAM) device 150, a read only memory (ROM) device 160, and a storage device 170 such as a hard disc drive or solid state memory. The storage device 170 may be an internal memory device or an external memory device such as a file storage device.

The computer software program codes and instructions for implementing the various embodiments of the present invention may be installed or saved on one or more of these memory devices. The data processor/controller unit 140 executes these computer software programs and instructions to perform the functions and carry out the operations to implement the process steps of the various embodiments of the present invention.

The server 100 typically also includes a display device 180 such as a video monitor or display screen which may be connected to the local I/O 120. The input device 110 and the display device 180 together provide a user interface (UI) which allows a user to interact with the server 100 to perform the steps of the process according to the various embodiments of the present invention.

The input device 110 and the display device 180 may be integrated into one unit, such as a touch screen display unit, to provide a more easy and convenient UI for user interaction with the server 100.

It is understood that the server 100 may be any suitable computer or computer system. Preferably for use, for example, by an online service provider, the server 100 is a webserver. However, for use by a member of the general public, the server 100 may be a desktop computer, a laptop computer, a notebook computer, a netbook computer, a tablet computer, a hand-held portable computer or electronic device, a smart phone, or any suitable data processing apparatus that has suitable data processing capabilities.

Referring to FIG. 3, there is shown a flow chart diagram illustrating an exemplary process according to one of the embodiments of the present invention. The process begins with a requesting server that wishes to access and work on a digital file stored in a file storage sending a status inquiry about the file. At this point the requesting server needs to find out from other servers whether any of them is using and working on the file.

All servers that have access to the file storage are “registered” with the file storage. The servers may register themselves with the file storage by providing detailed contact information such as an Internet Protocol (IP) address. Some of the servers may have done so when they save a file or files to the file storage. Registration of the server instances may be done by using a cloud-based Application Programming Interface (API) to list the instances. As a result the file storage will have a server registry containing information of all servers that have access to the file storage.

It is noted that this server registry is not a file registry, in that the server registry does not provide information of whether a file stored on the file storage is being accessed/used or not. Rather, the server registry provides information (e.g., IP address) of the servers which may/can access the files stored on the file storage.

Once the server registry is retrieved from the file storage, at Step S12 the requesting server first contacts all other servers via network calls under, for example, HTTP or Windows Communication Foundation (WCF) protocols, and sends a status query concerning a digital file that the requesting server wishes to do work on. The query includes a unique identification (ID) of the queried file.

At Step S14, each of the receiving servers will then proceed to check the status of the file. In the internal memory of each receiving server, a “lock list” is maintained and updated, which lists all “locked files” as will be explained later.

At Step S16 each receiving server checks to see whether the unique file ID received from the requesting server is on the lock list maintained in its internal memory. The lock list contains the IDs of files that have been previously entered as “locked” files.

At Step S18, if the file ID received from the requesting server is found on its internal lock list, then a receiving server will return a “failure” message to the requesting server. This means that the inquired file is in a locked status.

At Step S20, if the file ID received from the requesting server is not found on its internal lock list, then the receiving server will return a “success” message to the requesting server. Then as Step S22 the receiving serve will also add the inquired file ID to its internal lock list. This is how the lock list on the server is built. At the beginning there may be no entry in the lock list. As soon as the first inquiry with a file ID is received and a “success” message is returned, the lock list will have its first entry which is the file ID received from the first inquiry. As more inquiries are received later and more “success” messages are returned, the lock list is populated with the file IDs for which no match from previous entries of the lock list is found. This is an “automatic” process of building up or establishing the lock list on a server.

It is noted that Steps S12 is performed by the requesting server, as shown by the dotted box on the left hand side of FIG. 3, while Steps S14-S22 are performed by the receiving server, as shown by the dotted box on the right hand side of FIG. 3.

When the “failure” or “success” messages sent by the receiving servers are received by the requesting server, the following Steps S24-S36 are performed by the requesting server, as shown in FIG. 3.

At Step S24, after all the inquiries to the other servers are made and completed, i.e., the requesting server has received messages from all other servers, the requesting server will check for any “failure” messages returned by the receiving servers.

If a “failure” message exists in the returned messages, it means that the file is on a lock list of one of the receiving servers, which in turn means that the file is accessed and being worked on by another server. As a result at Step S26 the requesting server will push the file to the back of its work queue to be checked again later. The requesting server may work on other files in its work queue.

At Step S28 the requesting server recalls all the other servers that have returned “success” messages to remove the file from their internal lock lists. This is because when the requesting server made the initial inquiry, the receiving servers that have returned “success” messages “thought” the requesting server is going to access and work on the file and therefore have “preemptively” added the file ID onto their internal lock list (at Step S22).

Now since the requesting server is not going to access and work on the file at Step S26 (as another server has returned a “failure” message), it is no longer needed to keep the file ID on the internal lock lists of the receiving servers that have returned “success” messages to the requesting server.

After a predetermined time interval or period, for example every 15 seconds, at Step S30 the requesting server will send out an inquiry again about the status of the previously inquired file to see whether it is free to be accessed and worked on by the requesting server now. This step will be repeated periodically until no more “failure’ message is returned by any other servers.

This periodic checking schedule is preferably followed by all servers, which helps to automatically prioritize the order of which requesting server gets to access and work on the file next when it becomes free.

If there is no “failure” message returned after checking all the returned messages at Step S24, which means the inquired file is not on any other server's internal lock list so it is free to be accessed and worked on, then at Step S32 the requesting server will access and perform its work on the file. As an alternative, if the file ID is not added to the internal lock list of a receiving server at Step 22, then it may be added to the internal lock list of the requesting server following Step 32.

When the requesting server has finished working on the file, at Step 34 it will call all the other servers and send a notice to them to remove the file ID from their internal lock list. The requesting server will at Step S36 remove the file ID from its own internal lock list as well if the file ID is also on it (as a result of another inquiry of the same file by another server). As the file ID is also removed from the internal lock list of all other servers at Step S38, the file becomes now free to be accessed and worked on by any servers.

As a receiving server, if it has previously returned a “success” at Step S20 and later received a notice at Step S28, then at Step S38 it will remove the file ID from their internal lock list, and in this regard this Step S38 is performed by the receiving servers. On the other hand, regardless of what message it has returned, it will receive a notice at Step S34 together with all other receiving servers, and upon receiving that notice it will also remove the file ID from their internal lock list, and in this regard this Step S38 is performed by all servers. After the file ID is removed from the internal lock list at Step S38, the process is ended, as so indicated in FIG. 3.

This is a dynamic process of maintaining the lock list on a server through which the lock list is automatically updated by removing a file ID from the lock list either when it is actually not worked upon (i.e., Steps S26-S28) or when the work upon it has been performed and completed (i.e., Steps S32-S34).

The advantages and benefits of the various embodiments of the present invention method include, but are not limited to, that the peer-to-peer inquiring-responding process according to the exemplary embodiments of the present invention described above in detail has eliminated the need to have an administrative server for managing the shared file locks of a file storage. This peer-to-peer inquiring-responding process according to the exemplary embodiments of the present invention described above in detail has also eliminated the need to establish and maintain a centralized queue for each of the files store in the file storage.

This aspect of eliminating both the an administrative server, and a centralized queue for each of the files store in the file storage, for managing the shared file locks of a file storage is very suitable for servers and file storages connected in a peer-to-peer relationship and particularly in a cloud environment.

In addition, with the peer-to-peer inquiring-responding process according to the exemplary embodiments of the present invention described above in detail, an internal lock list is automatically built and dynamically updated at each peer-to-peer server without any need of a centralized administration and management.

Furthermore, when the predetermined periodic inquiry schedule is followed by all servers, it helps to prioritize the order of which the requesting servers get to access and work on a file after it becomes free.

Overall, the peer-to-peer inquiring-responding process according to the exemplary embodiments of the present invention described above in detail allows the users to prioritize and queue their work on files on a shared storage system without having to worry about any overlapping or duplication of work. It also allows the sharing files among peer-to-peer servers while maintaining file integrity.

It will be apparent to those skilled in the art that various modification and variations can be made in the method and related apparatus of the present invention without departing from the spirit or scope of the invention. Thus, it is intended that the present invention cover modifications and variations that come within the scope of the appended claims and their equivalents.

What is claimed is:

1. A method for managing the access and use of digital files stored in a file storage networked with multiple servers, comprising the steps of:
(a) a requesting server among the multiple servers that desires to access and use a file stored in the file storage sending to the other servers of the multiple servers a query containing an identification (ID) of the file;
(b) each of the other servers receiving the query checking an internal lock list to ascertain whether the file ID is listed therein,
(b)(i) if listed then returning a failure message to the requesting server;
(b)(ii) if not listed then returning a success message to the requesting server;
(c) the requesting server determining from all returning messages whether a failure message exists,
(c)(i) if exists then not to access and use the file, and sending repeated queries at a predetermined time interval; and
(c)(ii) if not exist then access and use the file, and sending a notice to all other servers when finishing using the file.

2. The method of claim 1, wherein the step (b)(ii) further comprises a step of adding the file ID to the internal lock list.

3. The method of claim 1, wherein the step (c)(i) further comprises a step of moving the file to an lower order of a work queue of the requesting server.

4. The method of claim 2, wherein the step (c)(i) further comprises a step of sending a notice to all other servers that return a success message.

5. The method of claim 4, further comprising a step of each server that has returned a success message at step (b)(ii) removing the file ID from its internal lock list.

6. The method of claim 2, further comprising a step of each of all other servers receiving the notice of step (c)(ii) removing the file ID from its internal lock list.

7. The method of claim 2, wherein the step (c)(ii) further comprises a step of removing the file ID from an internal lock list of the requesting server.

8. The method of claim 1, further comprising a step of the multiple servers registering with the file storage for accessing and using files stored in the file storage.

9. The method of claim 8, further comprising a step of the file storage maintaining a server registry of registered servers.

10. The method of claim 9, further comprising a step of the requesting server retrieving the server registry from the file storage.

11. The method of claim 9, wherein the server registry contains network address information of the registered servers.

12. A computer program product comprising a non-transitory computer usable medium having a computer readable code embodied therein for controlling a data processing apparatus, the computer readable program code configured to cause the data processing apparatus to execute a process for managing the access and use of digital files stored in a file storage networked with multiple servers, the process comprising the steps of:
(a) a requesting server among the multiple servers that desires to access and use a file stored in the file storage sending to the other servers of the multiple servers a query containing an identification (ID) of the file;
(b) each of the other servers receiving the query checking an internal lock list to ascertain whether the file ID is listed therein,
(b)(i) if listed then returning a failure message to the requesting server;
(b)(ii) if not listed then returning a success message to the requesting server;
(c) the requesting server determining from all returning messages whether a failure message exists,
(c)(i) if exists then not to access and use the file, and sending repeated queries at a predetermined time interval; and
(c)(ii) if not exist then access and use the file, and sending a notice to all other servers when finishing using the file.

13. The method of claim 12, wherein the step (b)(ii) further comprises a step of adding the file ID to the internal lock list.

14. The computer program product of claim 12, wherein the step (c)(i) further comprises a step of moving the file to an lower order of a work queue of the requesting server.

15. The computer program product of claim 13, wherein the step (c)(i) further comprises a step of sending a notice to all other servers that return a success message.

16. The computer program product of claim 15, wherein the process further comprises a step of each server that has returned a success message at step (b)(ii) removing the file ID from its internal lock list.

17. The computer program product of claim 13, wherein the process further comprises a step of each of all other servers receiving the notice of step (c)(ii) removing the file ID from its internal lock list.

18. The computer program product of claim 13, wherein the step (c)(ii) further comprises a step of removing the file ID from an internal lock list of the requesting server.

19. The computer program product of claim 11, wherein the process further comprises a step of the multiple servers registering with the file storage for accessing and using files stored in the file storage.

20. The computer program product of claim 19, wherein the process further comprises a step of the file storage maintaining a server registry of registered servers.

21. The computer program product of claim 20, wherein the process further comprises a step of the requesting server retrieving the server registry from the file storage.

22. The computer program product of claim 12, wherein the server registry contains network address information of the registered servers.
